(19) United States
(12) Patent Application Publication
(10) Pub. No.: US 2021/0206470 A1
(43) Pub. Date: Jul. 8, 2021

(54) WING DESIGN FOR VTOL AIRCRAFT LANDING IN CONSTRAINED SPACES

(71) Applicant: SkyX Limited, Woodbridge (CA)

(72) Inventors: Jason Braverman, Thornill (CA); Yuri Knafo, Richmond Hill (CA)

(21) Appl. No.: 17/025,084

(22) Filed: Sep. 18, 2020

Related U.S. Application Data
(60) Provisional application No. 62/902,599, filed on Sep. 19, 2019.

(51) Int. Cl. B64C 3/18; B64C 3/48; B64C 29/00

(52) U.S. Cl. CPC B64C 3/185; B64C 29/00; B64C 3/48

(57) ABSTRACT

A telescopic spar mechanism is provided. The telescopic spar mechanism comprises a housing, an outer tube rotatably coupled to the housing, and an inner tube received within the outer tube. The outer tube having flat walled threads formed on an inside. The inner tube having a plurality of spaced apart bearings secured to an outside of the inner tube, where the plurality of bearings are received within lands of the threads of the outer tube. The telescopic spar mechanism is used in combination with a wing assembly to increase the wing size of VTOL aircrafts.

### CROSS REFERENCE TO RELATED APPLICATIONS

The current application claims priority to U.S. Provisional application Ser. No. 62/902,599 Filed Sep. 19, 2019 and titled “Method and Design for VTOL Aircraft Landing In Constrained Spaced,” the entire contents of which are incorporated herein by reference in their entirety for all purposes.

### TECHNICAL FIELD

The current invention relates to vertical take-off and landing (VTOL) aircraft, in particular to a VTOL aircraft that can land and be stored in a constrained enclosure.

### BACKGROUND ART

Aerospace science indicates that in order to achieve long range flights with aircrafts, ideal designs would have a large wing surface area, thus allowing the aircraft to make maximum use of the airflow to provide lift, and lowering the cost of power to reach the destination. When one considers applying this to the area of unmanned aerial vehicle (UAV) systems, operating in an autonomous nature, the UAV is generally landing in a defined area, or shelter. This shelter is usually a fabricated structure with power, providing both safety, and refueling for the UAV. These structures have constrained spaces, and present a challenge when aircraft designers want to build systems capable of long range surveillance.

Some current UAVs for long range surveillance range from QuadCopters to Fixed Wing VTOL Systems. Quadcopter type systems lack the wingform to fly long range, and Fixed Wing VTOL aircrafts tend to have wingspans over several meters in length, with 5 meters not being uncommon. With these large wingspans, it would be extremely difficult, if not impossible to create a ground station to house the aircraft. There have been attempts at creating folding wings (for example, F4U Corsair in WW2 and F18 Hornet), and Swing Wing Designs (for example, the F14 Tomcat and the F111 Aardvark). However, these systems are generally very complex, and heavy, making them inefficient for UAV designs.

A current problem exists around meeting the needs of the ground station, i.e., the maximum size aircraft one can fit in a reasonable sized ground station, and the science of aerodynamics, which indicates what is needed using modern technology to achieve long range flights. Currently, there are no stations larger than a standard 20 ft shipping container, in fact, currently 20 ft is the largest operational ground station for a UAV or other unmanned VTOL aircraft. These problems can exist anywhere space is required to store the aircraft, i.e., a ship, aircraft carrier or even an airport.

Accordingly, an additional, alternative, and/or improved method of increasing the range of a VTOL aircraft taking off from a constrained enclosure is desired.

### SUMMARY

In accordance with the present disclosure there is provided a telescopic spar comprising: a housing; an outer tube rotatably coupled to the housing, the outer tube having flat walled threads formed on an inside of the outer tube; an inner tube received within the outer tube and having a plurality of spaced apart bearings secured to an outside of the inner tube, the plurality of bearings being received within lands of the threads of the outer tube.

In accordance with the present disclosure there is further provided a telescopic spar comprising: a housing; an outer tube rotatably coupled to the housing, the outer tube having a plurality of spaced apart bearings secured to an inside of the outer tube; an inner tube received within the outer tube, the inner tube having flat walled threads formed on an outside, the plurality of bearings of the outer tube being received within lands of the threads of the inner tube.

In accordance with the present disclosure there is further provided a drone capable of horizontal flight comprising: a telescoping wing section comprising: a plurality of telescoping wing sections; a telescoping spar as described above for extending and retracting the plurality of telescoping wing sections.

In accordance with the present disclosure there is provided a telescopic spar for an extendable/retractable wing, the telescopic spar comprising: a housing; and nested tubes rotatably secured to the housing, the nested tubes comprising: a bearing tube having a bearing secured to a surface of the bearing tube; and a threaded tube having walled threads formed on a surface of the threaded tube adjacent the to surface of the bearing tube that the bearing is secured to, wherein the bearing of the bearing tube being received within lands of the threads of the inner tube.

In a further embodiment, the telescopic spar further comprises a plurality of bearings secured to the surface of the bearing tube, the plurality of bearings including the bearing secured to the surface.

In a further embodiment of the telescopic spar, the plurality of bearings are spaced apart from each other in a radial direction of the nested tubes.

In a further embodiment of the telescopic spar, the threads of the threaded tube comprise flat walled crests, roots and flanks.

In a further embodiment of the telescopic spar, the threads of the threaded tube are rectangular threads.

In a further embodiment of the telescopic spar, a flat surface of the crests of the threaded tube bear against the surface of the bearing tube and a flat surface of the flanks of the threaded tube bearing against a surface of the bearing.

In a further embodiment of the telescopic spar, the bearing surface further comprising one or more support bearings located on the surface of the bearing tube, each of the one or more support bearings sized to be received within the threads of the threaded tube and having a surface that bears against the root of the threads without contacting the flank of the thread.

In a further embodiment, the telescopic spar further comprises a drive motor secured to the housing and coupled to an outer tube of the nested tubes, the drive motor, when operated causing the outer tube to rotate.

In a further embodiment of the telescopic spar, the drive motor and the nested tubes are coaxially aligned,

In a further embodiment of the telescopic spar, the drive motor is coupled to the outer tube through a planetary gear set.

In a further embodiment of the telescopic spar, the threaded tube comprises an inner tube of the nested tubes with the threads formed on an outer surface of the threaded tube and the bearing tube comprises an outer tube of the nested tubes with the bearing secured to an inner surface of bearing tube.

In a further embodiment of the telescopic spar, the threaded tube comprises an outer tube of the nested tubes with the threads formed on an inner surface of the threaded tube and the bearing tube comprises an inner tube of the nested tubes with the bearing secured to an outer surface of bearing tube.

In a further embodiment of the telescopic spar, the nested tubes comprise one or more additional nested tubes with corresponding threads and bearings.

In accordance with the present disclosure there is provided a retractable/extendable wing comprising: a root wing section; a wingtip section nested within the first wing section; and a telescopic spar comprising: a housing secured to the root wing section; and nested tubes rotatably secured to the housing, the nested tubes comprising: a bearing tube having a bearing secured to a surface of the bearing tube; and a threaded tube having walled threads formed on a surface of the threaded tube adjacent the to surface of the bearing tube that the bearing is secured to, wherein the bearing of the bearing tube being received within lands of the threads of the inner tube, wherein rotation of one of the bearing tube or the threaded tube causes the other one of the bearing tube or the threaded tube to extend or retract with an end of the other one of the bearing tube or the threaded tube secured to the wingtip section causing the wingtip section to extend or retract relative to the root wing section.

In a further embodiment of the retractable/extendable wing further comprises one or more intermediary wing sections nested between the wingtip section and the root wing section.

In accordance with the present disclosure there is provided a drone capable of horizontal flight comprising: a central body with a pair of wings extending from opposite sides of the central body, each of the wings comprising a retractable/extendable wing comprising: a root wing section fixed to the central body; a wingtip section nested within the first wing section; and a telescopic spar comprising: a housing secured to the root wing section or the central body; and nested tubes rotatably secured to the housing, the nested tubes comprising: a bearing tube having a bearing secured to a surface of the bearing tube; and a threaded tube having walled threads formed on a surface of the threaded tube adjacent the to surface of the bearing tube that the bearing is secured to, wherein the bearing of the bearing tube being received within lands of the threads of the inner tube, wherein rotation of one of the bearing tube or the threaded tube causes the other one of the bearing tube or the threaded tube to extend or retract with an end of the other one of the bearing tube or the threaded tube secured to the wingtip section causing the wingtip section to extend or retract relative to the root wing section.

### BRIEF DESCRIPTION OF DRAWINGS

Further features and advantages of the present disclosure will become apparent from the following detailed description, taken in combination with the appended drawings, in which:

FIG. 1 depicts a VTOL-capable vehicle with extendable/retractable wings;

FIG. 2A depicts a telescopic spar in an extended position;

FIG. 2B depicts a telescopic spar in a retracted position;

FIG. 3A depicts a retractable/extendable aerofoil or wing in a retracted position;

FIG. 3B depicts the retractable/extendable aerofoil or wing in an extended position;

FIG. 4 depicts a cross-section of the telescopic spar mechanism;

FIG. 5 depicts threads and bearings of outer and inner tubes;

FIG. 6 depicts a tube with bearings attached to its outer surface;

FIG. 7 depicts a cross-section of a telescopic spar;

FIG. 8 depicts a drive assembly;

FIG. 9 depicts a cross section of an outer tube and motor assembly;

FIG. 10A depicts an aircraft with fully retracted wings;

FIG. 10B depicts the aircraft with partially retracted/extended wings;

FIG. 10C depicts the aircraft with fully extended wings;

FIG. 11A depicts a male and female mold for a wing section; and

FIG. 11B depicts the male and female molds assembled.

### DETAILED DESCRIPTION

A vertical takeoff and landing (VTOL) capable autonomous or semi-autonomous vehicle can be provided with extendable/retractable wings. By extending the wings the VTOL capable vehicle benefits from having a large wingspan and by retracting the wings, the VTOL vehicle can benefit from having a small wingspan allowing the vehicle to be stored in a small footprint. Each of the wings comprise at least two sections nested within each other that allow the wing to extend and retract. A telescopic spar that comprises one or more nested tubes can be extended/retracted by rotating one of the tubes. In addition to providing a means for extending/retracting the wing sections, the telescopic spar can also provide structural support to the wing when extended. The

As described further herein a telescopic spar for allowing wings of VTOL aircrafts to extend from the root of the center of the fuselage in such a way as to create a large wing area without requiring complex or heavy gearing systems. This is done by creating wing sections, which may be formed of carbon graphite composite, that fit inside each other in a telescoping or nested fashion. This telescoping mechanism allows the wing to reduce in size dramatically, and increase in size when needed for long range cruising. This would give the aircraft the ability to land, or be stored, in tight spaces, and fly long range just like a regular fixed wing aircraft.

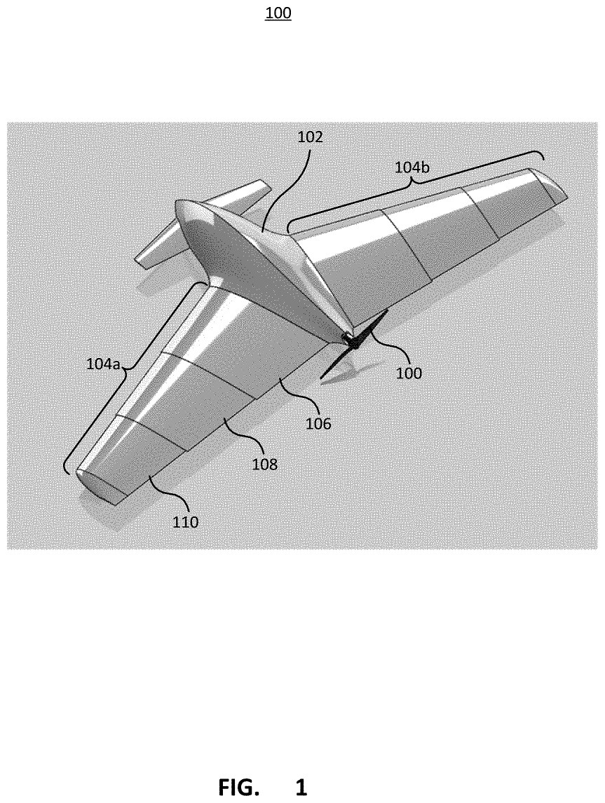

FIG. 1 depicts a VTOL-capable vehicle with extendable/retractable wings. The VTOL vehicle 100 may have an embodiment of the telescopic wing aircraft assembly. The vehicle 100 is depicted as having a canard/ foreplane configuration although any type of winged vehicle configuration is possible. The vehicle 100 comprises a central body of fuselage 102 with a pair of wings 104a, 104b extending from opposite sides of the body 102. Each of the wings 104a, 104b are formed in a similar manner, which is described for wing 104a. The wing comprises a root wing section 106 which can be fixed to the body 102 or formed integrally with the body 102. The wing 104a further comprises two additional sections 108 and 110 that are nested within each other in a telescoping manner. The middle section 108 can be retracted within the root section 106 while the wingtip section 110 can be retracted within the middle section 108. The telescopic wing assembly may be used for VTOL platforms or for other aircraft systems. The scale of the telescopic spar mechanism can greatly vary allowing for a wingspan of many different sizes.

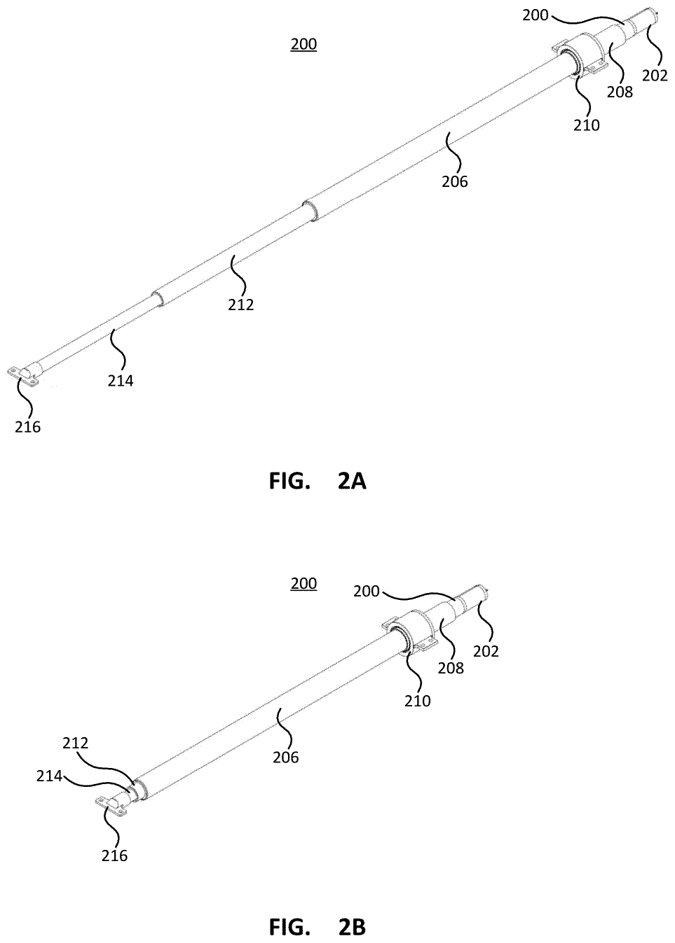

FIG. 2A depicts a telescopic spar in an extended position. FIG. 2B depicts a telescopic spar in a retracted position. The telescopic spar 200 may be extended/retracted using an internal threaded between tubes of the spar, which is described in further detail below. The thread drive mechanism for the telescopic spar allows for very precise and controlled extension of the telescoping spar while providing sufficient structural strength to support the wing in the extended position.

The telescopic spar mechanism may comprise a drive motor 202 for driving the extension and retraction of the telescopic spar. As described in further detail below, rotating the outer tube 206 causes the telescopic spar to extend/retract. The drive motor 202 may be coupled to an outer one of the nested tubes through gearbox 204, which may be for example a planetary gear set. The gearbox 204 may be coupled to an outer tube 206 which is rotatably coupled to a housing 208. The housing 208 may comprise a bearing system, such as a ball bearing 210 for supporting the outer tube 206 while allowing the tube to easily rotate. A first inner tube 212 may be received within the outer tune 206, such that the first inner tube 212 is able to rotate within the outer tube. A second inner tube 214 may be received within first inner tube 212. The connection of the first inner tube 212 and the second inner tube 214 allows the first inner tube 212 to rotate. The second inner tube 214 has an end cap 216 that can be fastened to a wing section. With the end cap secured to a wing section, the second inner tube 214 may be prevented from any rotation.

In the fully retracted position, substantially all of the second inner tube 214 is received within the first inner tube 212 and substantially all of the first inner tube 212, along with the second inner tube 214 is received within the outer tube 206.

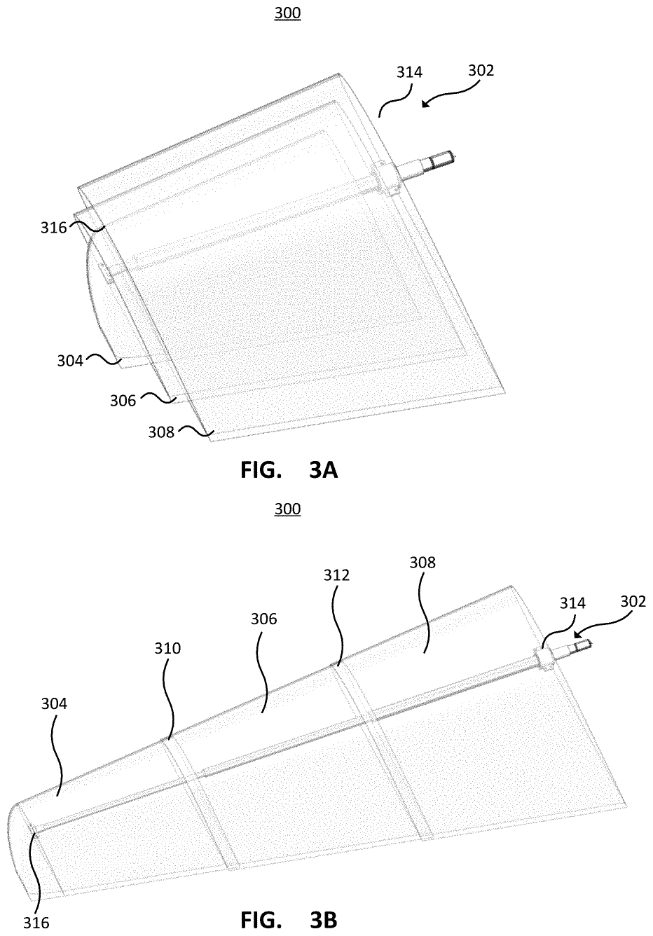

FIG. 3A depicts a retractable/extendable aerofoil or wing in a retracted position. FIG. 3B depicts the retractable/extendable aerofoil or wing in an extended position. The wing 300 may be used as the wing 104a described above with reference to FIG. 1. As depicted, a telescopic spar 302 is located within the wing 300 in order to extend and retract the wing. The telescopic spar 302 may be provided by the telescopic spar 200 described above with reference to FIGS. 2A and 2B. The wing 300 comprises a root wing section 304, an intermediate wing section 306 that is nested within the root wing section 304 and a wingtip section 308 that is nested within the intermediate wing section 306. As depicted, the wing sections 304, 306, 308 can be substantially extended so that each section extends past the other. Overlapping end sections of each adjacent section may have an interlocking portions 310, 312 that may help fix the wing sections together when extended.

The telescopic spar 302 may have housing 314 that is secured to the root wing section 302, or possibly the fuselage that the root wing section is secured to. The outer tube of the telescopic spar 302 is rotatably coupled to the housing so that the outer tube can be rotated by the motor, which causes the other tubes to extend out of or retract into the outer tube. An end of the inner most tube may have an end cap 316 that is secured to the wingtip section so that extension/retraction of the telescopic spar 302 results in extending/retracting of the wing.

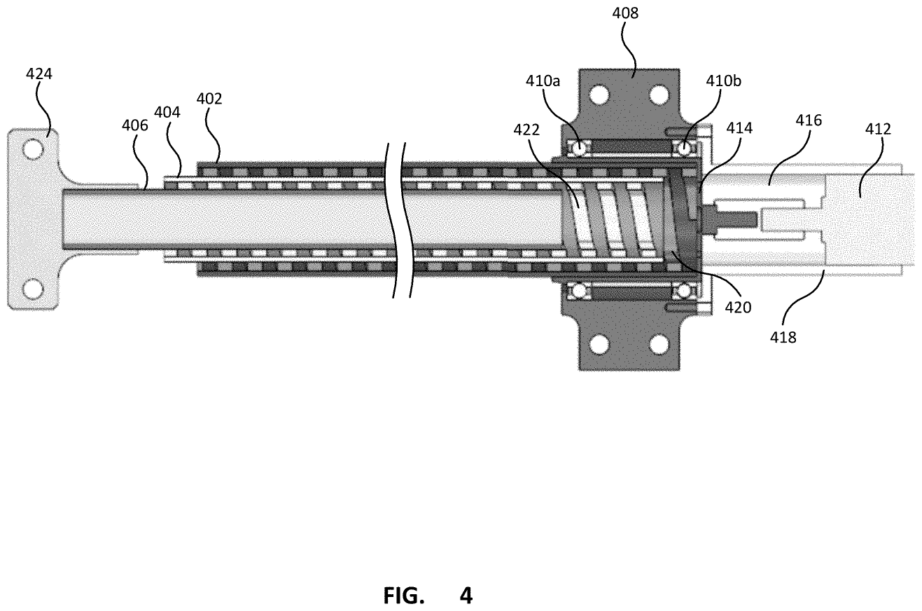

FIG. 4 depicts a cross-section of the telescopic spar mechanism. As depicted in FIG. 4, the telescopic spar mechanism 400, which may be used as the telescopic spar mechanism described above comprises an outer tube 402, an intermediate tube 404 and an inner tube 406. It will be appreciated that although the spar 400 is depicted with three nested tubes, telescopic spars may be provided with two or more nested tubes. The outer tube 402 is rotatably coupled to a housing 408 in a manner that holds the tube securely in place while allowing it to rotate. The rotatable coupling may be provided, for example, by one or more roller bearings 410a, 410b. A tube connector 414 can connect the outer tube 402 to a motor and gear set 414 through a coupler 416. The connection between the motor and the outer tube allows the motor to rotate the outer tube 402 in the housing 408. may be coupled to the outer tube 402. The coupling and the motor/gear set may be secured to the housing, for example by a motor support housing 418 that can be secured to the housing 408.

The inside surfaces of the outer tube 402 and the intermediate tube 404 have a threaded surface. The threaded surfaces 420, 422 of each of the tubes 402, 404 may extend along substantially the entire width of the tubes. Each of the tubes adjacent to the threaded surfaces 420, 422, that is the intermediate tube 404 and inner tube 406 in FIG. 4, has at least one bearing (not visible in FIG. 4) located on its outer surface. The bearings are fixed in position on the respective tubes and fit within the thread of the adjacent tube. Accordingly, since the outer tube 402 can freely rotate while the inner tube 406 cannot freely rotate as a result of the end of the inner tube 406 being secured by the end cap 424, the bearings follow the threads and cause the tubes to extend or retract. The threaded portions of the tubes may include a stopper, either within the threaded portion, or possibly as a cap on the end of the tube, that can prevent the bearing from escaping the threaded portion when the tubes are extended.

Although the threads 420, 422 are depicted as being on the inside surface of the tubes 402, 404 and the bearings on the outside surface of the tubes 404, 406 it is possible for the features to be reversed. That is, the threads may be located on the outside surface of tubes 404, 406 and the bearings located on the interior surface of the tubes 402, 404. If the bearings are located on the inside surface of the tubes, they should be located toward the extension end of the tubes in order to allow the tube to be extended further out. In contrast, if the bearings are located on the outside surface of the tubes, the bearings may be located toward the retraction end of the tubes.

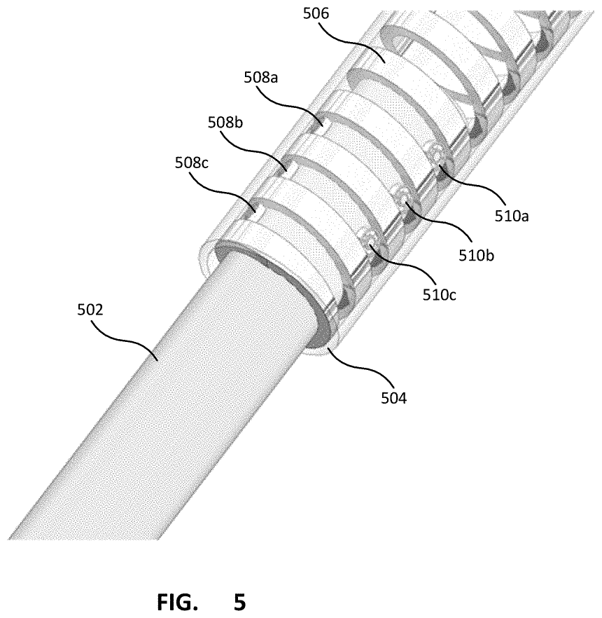

FIG. 5 depicts threads and bearings of outer and inner tubes. The inner tube 502 is partially received within an outer tube 504, depicted as being translucent. The outer tube 504 has threads on an interior surface. As depicted the Threads may have a substantially flat surfaces including a flat roots, crests and flanks. Further, the threads may have a rectangular shape as depicted or may have other profile shapes. Additionally, the crests of the thread may have a flat profile and provide a baring surface for bearing against the inner tube 502 in order to provide support to the inner tube when extended. The pitch of the thread 506 is sufficient to receive bearings 508a, 508b, 508c, 510a, 510b, 510c that are attached to the outer surface of the inner tube 502. The bearings 508a-510c may be arranged toward an end of the inner tube 502 in order to allow the inner tube 502 to extend out of the outer tube 504. The bearings are depicted as roller bearings although other types of bearings are possible.

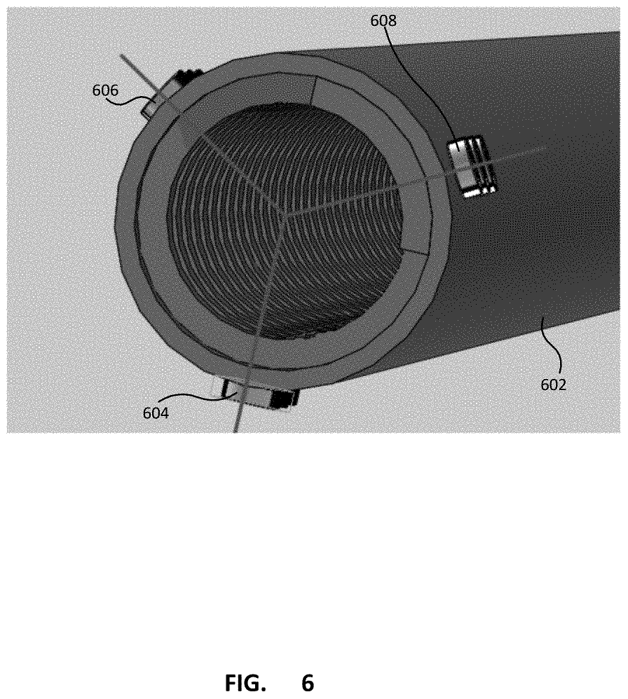

FIG. 6 depicts a tube with bearings attached to its outer surface. The tube 602 is depicted as having three groups of bearings 604, 606, 608 spaced about the outer tube. The groups of bearings are depicted as being spaced 120° apart from each other. Each group of bearings is depicted as having three bearings spaced apart longitudinal from each other along the outer surface of the tube. Other arrangements of bearings on the outer surface of a tube can be used.

The bearings may be phased at 120° around the tubes in rows of 1 or more bearings per phase as depicted. Having more than two phases on each tube provides stability for the mechanism while each tube is being extended or retracted. It will be appreciated that putting more than two points on a plane creates a stable condition. The more phases and bearings used in a row, the greater the force that can be applied due to multiple points of contact on the threads that distribute the load.

The interaction of the bearings' 604, 606, 608 outer face with the flanks of the thread of the tubes creates a static friction condition versus kinetic friction compared to the interaction of conventional nut and bolt scenario where the friction is kinetic. The static friction reduces wear of the components and allows for the use of lightweight materials such as carbon fiber, wood and even high density foam for ultralight applications. This may result in a high load capacity ultralight telescopic screw spar system.

The ball bearings 604, 606, 608 may be used to significantly reduce the friction between the moving parts. In a typical screw and nut system, the friction between the parts is kinetic, and a large portion of the threads in the screw and nut are sliding one against each other, generating friction, wear and heat. The use of ball bearings on the tubes eliminates the friction, wear, and heat generated in screw and nut systems, allowing the use of lighter and more porous materials than metals. This may also reduce wear, and during continuous operation of the system may allow for no heat to be generated, preventing failure of the mechanism.

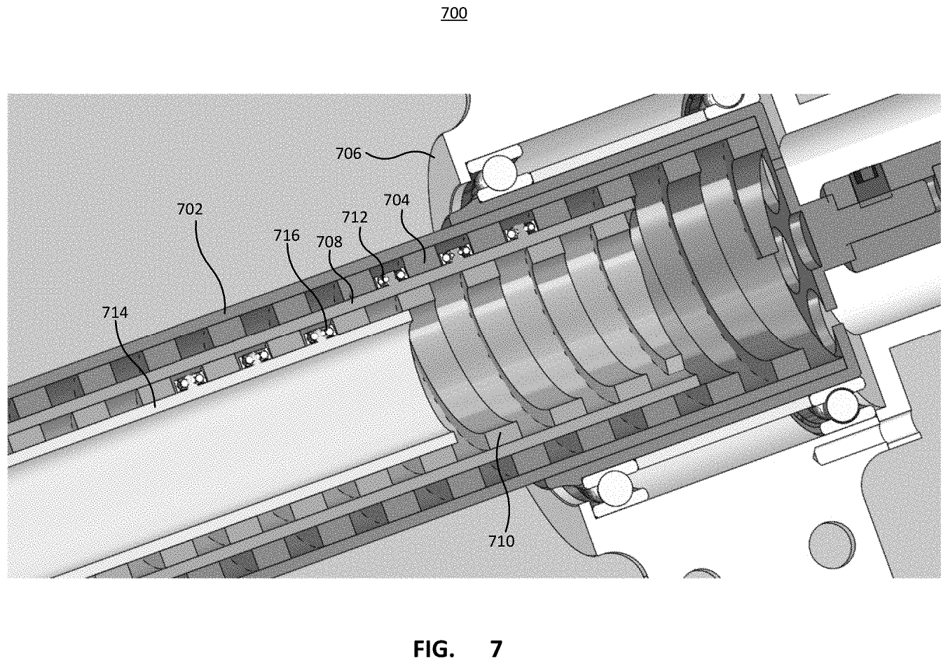

FIG. 7 depicts a cross-section of a telescopic spar. The telescopic spar 700 is similar to the spars described above. The telescopic spar 700 comprises an outer tube 702 that has a rectangular profiled thread 704 on an interior surface of the tube. The outer tube 702 is rotatably coupled to a housing 706 and is secured to a motor capable of rotating the outer tube 702. An intermediate tube 708 is nested within the outer tube 702. The intermediate tube 708 also has a rectangular profiled thread 710 on its interior surface. A plurality of bearings 712 are secured to an outer surface of the intermediate tube 708 and are arranged to fit within the lands of the thread 704. A third inner tube 714 is nested within the intermediate tube 708 and has a plurality of bearings 716 secured to an outer surface of the inner tube 714. The bearings 716 of the inner tube 714 are arranged to fit within the lands of the threads 710. As the outer tube is rotated, and the inner tube 714 secured against rotation, the bearings 712, 716 will be forced to follow the threads 704, 710 causing the tubes to extend/retract relative to the outer tube 702. Although not depicted in FIG. 7, additional bearing surfaces may be provided on the tubes similar to the bearings 712, 716. The additional bearing surfaces may be sized to be received within the threads of the adjacent tube and provide a surface that bears against the root of the threads without contacting the flank of the thread and as such do not interfere with the rotation of the threads but can provide additional strength to the telescopic spar.

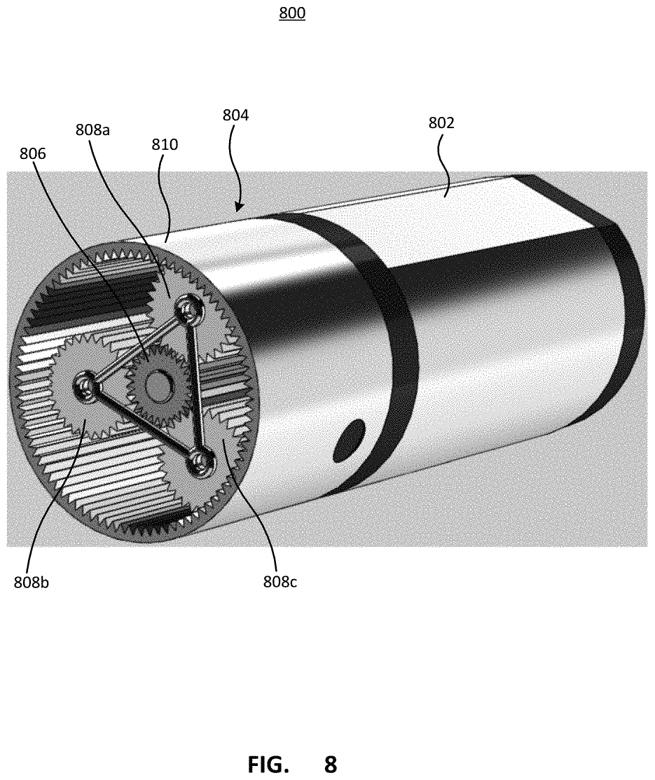

FIG. 8 depicts a drive assembly. The drive assembly 800 comprises a motor 802 connected to a gear set 804, which is depicted as a planetary gear set although other types of gears are possible. The motor 802 may be an electric motor. The gear set 804 bay provide a reduction from a motor input 806 to the gear set 804 output (not depicted). The motor output 806 may have a plurality of planetary gears or pinions 808a, 808b, 808c connected to it, with an exterior ring gear 810 connected to the planetary gears 808a, 808b, 808c. A face plate with an output shaft or similar structure may be secured to the ring gear 810. The gear set 804 may provide a gear ratio of 1:100 which significantly reduces speed of the motor and increases torque. Having high torque allows the use of a lightweight motor to actuate the mechanism while reducing the speed of actuation. It will be appreciated that speed may not be necessary for a telescopic wing application, where it may be acceptable to take time to fully extend or retract the wings.

The motor 802 may be controlled via a flight controller or onboard computer/PLC. The motor 802 may have a built in encoder, and its control unit may be programmed to rotate only a certain amount of rotations until the wing is fully extended. Other techniques for stopping the motor when the wing is fully retracted or extended.

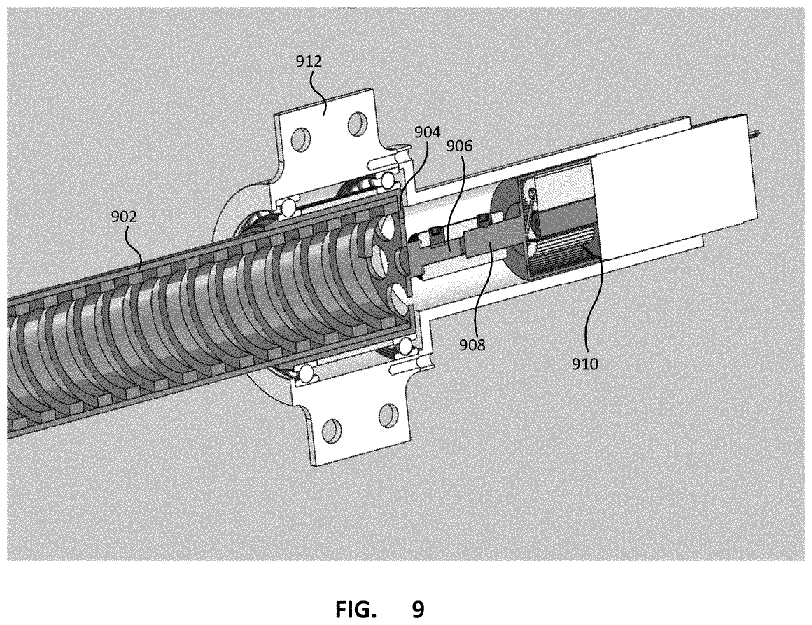

FIG. 9 depicts a cross section of an outer tube and motor assembly. As depicted an outer tube 902 may be secured to a coupler 904 that has an output shaft 906. The output shaft 906 of the coupler 904 may be secured to the output shaft 908 of the gear set and motor assembly 910.

As shown in FIG. 9, the output of the gear set 908 may be connected to outer tube 902 via a coupler 904. The housing 912 may be fixed to the airframe of the aircraft and the outside tube 902 may be rotatably secured to the housing 912 via bearings, which are depicted as ball bearings 914, 916. When the motor is operated, the outer tube rotates in a clockwise or counter clockwise direction. In one direction, the outer tube will rotate and push an intermediate tube with bearings within the lands of the threads away from the housing, thereby extending the telescopic spar and so any attached wing sections. In the opposite direction, the outer tube 902 will rotate and pull the intermediate tube towards the housing, thereby retracting the telescopic spar and so any attached wing sections.

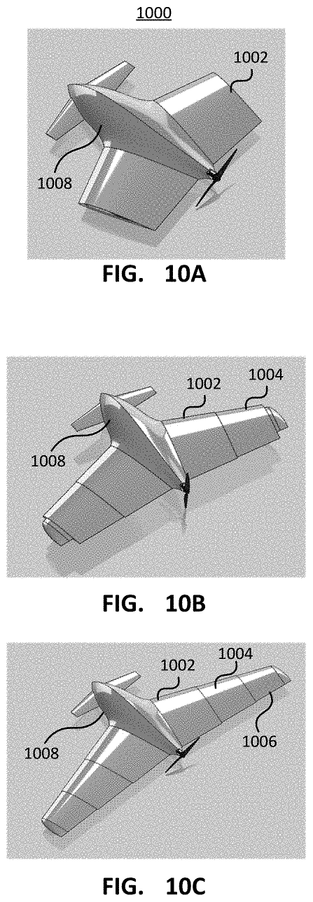

FIG. 10A depicts an aircraft with fully retracted wings. FIG. 10B depicts the aircraft with partially retracted/extended wings. FIG. 10C depicts the aircraft with fully extended wings. The aircraft 1000 comprises a telescopic wing assembly that is driven by a telescopic spar mechanism as described above. The telescopic wing of the aircraft may comprise a plurality of wing sections 1002, 1004, 1006, each wing section may be tapered to fit within the previous wing section. The end wing section 1006, which when extended is furthest from a fuselage of the aircraft 1008, may be secured to an end cap of the internal telescopic spar. The wing section 1002 closest to the fuselage 1008, when in the extended position, may be secured to the housing, or to the airframe of the aircraft. The end wing section 1006 may be smallest in size, and may be formed so that the end of the wing section 1006, closest to the housing, is received in the opening of intermediary wing section 1004. Similarly, intermediary wing section 1004 may be formed so that the end of intermediary wing section 1004, closest to the housing, is received in the opening of the root wing section 1002.

To transition into the extended position, the motor operated engaged causing the outer tube of the telescopic spar to rotate in one direction. The rotation of the outer tube may then force the bearings of the intermediate tube that are in contact with the threads of the outer tube to roll within the lands of the threads, which may cause the intermediate tube to rotate. The rotation of the intermediate tube may then force the bearings of inner tube that are in contact with the threads of the intermediate tube to roll within the lands of the threads of tube. This causes intermediate tube to extend away from the housing. Once the inner tube is fully extended it will prevent the intermediate tube from rotating, causing it to extend away from the housing as the outer tube continues to rotate. This allows the telescopic wing aircraft assembly to extend to its full length. As described above, the inner tube C is prevented from rotating due to the end cap which is fixed to the outside telescopic section of the wing (the wing tip). Although the operation is described as fully extending the inner tube before extending the intermediary tube, it is possible for the intermediary tube to partially extend/retract as the inner tube is extending/retracting.

During transition from the retracted position to the extended position, the wing extends to the point where the tapered geometry of each wing section or panel meet and lock together. At that point the wing cannot extend more, and the telescopic spar may be programmed to stop the extension at this point. The wing assembly may act as a linear rail, where the wing sections are retracted or extended without rotating.

The wing sections may be formed from carbon fiber or other materials. The overlapping portions of the wing sections, when extended, may require a precise fit in order to provide solid wing structure. The wing sections may be formed in molds with corresponding male and female molds used for portions requiring a precise fit.

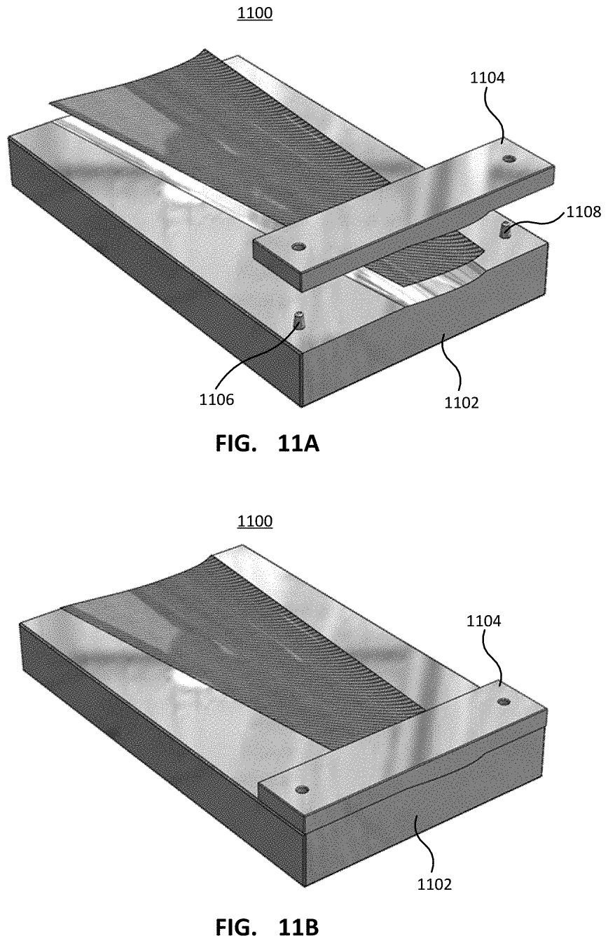

FIG. 11A depicts a male and female mold for a wing section. FIG. 11B depicts the male and female molds assembled. The connection between the wing sections when fully extended, may require a high precision skin thickness on the overlapping ends of each wing section or panel. The outer diameter (OD) and inner diameter (ID) of each of the wing sections or panels may be critical for proper transition between retracted and extended positions. It will be appreciated that for the inner end (closest to the housing) of the wing sections or panels, only the OD may be critical as the wing extends to the point where the tapered geometry of each wing section or panel meet and lock together.

The wing sections may be formed with a manufacturing process to create high precision telescopic wing sections or panels. The manufacturing process comprises a mold assembly 1100. The wing sections of the wing assembly may be formed using carbon fiber, Kevlar and/or fiberglass materials.

The mold assembly 1100 may be used for producing high precision composite panels for the wing sections. The outside surface of the panels is formed in a precise manner due to being molded in a CNC machined female mold 1102. The ID of the contact points between the wing sections are on the inside of the composite panel and are formed in a precise manner by a male insert mold 1104 that may be used while curing. The male insert mold 1104 may be aligned with the female mold by one or more alignment features, depicted as pins 1106, 1108. The mold assembly 1100 allows for a high tolerance in the thickness of the composite panel in critical areas where the composite panels mate to other telescoping panels when wing is in the retracted position.

The tubes of the telescopic spar and their threads may be formed of carbon fiber or Kevlar structures, which may allow for strong lightweight construction with customizable directional strength. The tube and threads may be integrally formed with each other or the tube and threads may be formed separately and affixed together, for example using an adhesive, welding, or other way of fusing the threads and tubes together. The bearings of the tubes may distribute loads over a greater surface area on the precision machined threads of the tubes. This allows the threads to be formed with carbon fiber material. The strong lightweight construction and distributed loads on precision machined threads allow for large diameter, and high load carrying capability in a multiple axis ball screw style system that is telescopic and lightweight.

Although the components of the telescopic spar mechanism, such as, the threads, housing and tubes, have been described as being formed of carbon fiber, other materials such as Titanium or Aluminum alloys can be used. Titanium and Aluminum alloys may allow for heavier load carrying capability and may cause the assembly to have a heavier weight.

It will be apparent to persons skilled in the art that a number of variations and modifications can be made without departing from the scope of the invention. Although specific embodiments are described herein, it will be appreciated that modifications may be made to the embodiments without departing from the scope of the current teachings. Accordingly, the scope of the invention should not be limited by the specific embodiments set forth, but should be given the broadest interpretation consistent with the teachings of the description as a whole.

1. A telescopic spar for an extendable/retractable aerofoil, the telescopic spar comprising:
a housing; and
nested tubes rotatably secured to the housing, the nested tubes comprising:
a bearing tube having a bearing secured to a surface of the bearing tube; and
a threaded tube having walled threads formed on a surface of the threaded tube adjacent the to surface of the bearing tube that the bearing is secured to, wherein the bearing of the bearing tube being received within lands of the threads of the inner tube.

2. The telescopic spar of claim 1: further comprising a plurality of bearings secured to the surface of the bearing tube, the plurality of bearings including the bearing secured to the surface.

3. The telescopic spar of claim 2, wherein the plurality of bearings are spaced apart from each other in a radial direction of the nested tubes.

4. The telescopic spar of claim 1, wherein the threads of the threaded tube comprise flat walled crests, roots and flanks.

5. The telescopic spar of claim 4, wherein the threads of the threaded tube are rectangular threads.

6. The telescopic spar of claim 4, wherein a flat surface of the crests of the threaded tube bear against the surface of the bearing tube and a flat surface of the flanks of the threaded tube bearing against a surface of the bearing.

7. The telescopic spar of claim 6, wherein the bearing surface further comprising one or more support bearings located on the surface of the bearing tube, each of the one or more support bearings sized to be received within the threads of the threaded tube and having a surface that bears against the root of the threads without contacting the flank of the thread.

8. The telescopic spar of claim 1, further comprising a drive motor secured to the housing and coupled to an outer tube of the nested tubes, the drive motor, when operated causing the outer tube to rotate.

9. The telescopic spar of claim 8, wherein the drive motor and the nested tubes are coaxially aligned,

10. The telescopic spar of claim 9, wherein the drive motor is coupled to the outer tube through a planetary gear set.

11. The telescopic spar of claim 1, wherein the threaded tube comprises an inner tube of the nested tubes with the threads formed on an outer surface of the threaded tube and the bearing tube comprises an outer tube of the nested tubes with the bearing secured to an inner surface of bearing tube

12. The telescopic spar of claim 1, wherein the threaded tube comprises an outer tube of the nested tubes with the threads formed on an inner surface of the threaded tube and the bearing tube comprises an inner tube of the nested tubes with the bearing secured to an outer surface of bearing tube.

13. The telescopic spar of claim 1, wherein the nested tubes comprise one or more additional nested tubes with corresponding threads and bearings.

14. A retractable/extendable aerofoil comprising:
a root wing section;
a wingtip section nested within the first wing section; and
a telescopic spar comprising:
a housing secured to the root wing section; and
nested tubes rotatably secured to the housing, the nested tubes comprising:
a bearing tube having a bearing secured to a surface of the bearing tube; and
a threaded tube having walled threads formed on a surface of the threaded tube adjacent the to surface of the bearing tube that the bearing is secured to, wherein the bearing of the bearing tube being received within lands of the threads of the inner tube,
wherein rotation of one of the bearing tube or the threaded tube causes the other one of the bearing tube or the threaded tube to extend or retract with an end of the other one of the bearing tube or the threaded tube secured to the wingtip section causing the wingtip section to extend or retract relative to the root wing section.

15. The retractable/extendable aerofoil of claim 14, further comprising one or more intermediary wing sections nested between the wingtip section and the root wing section.

16. A drone capable of horizontal flight comprising:
a central body with a pair of wings extending from opposite sides of the central body, each of the wings comprising a retractable/extendable aerofoil comprising:
a root wing section fixed to the central body;
a wingtip section nested within the first wing section; and
a telescopic spar comprising:
a housing secured to the root wing section or the central body; and
nested tubes rotatably secured to the housing, the nested tubes comprising:
a bearing tube having a bearing secured to a surface of the bearing tube; and
a threaded tube having walled threads formed on a surface of the threaded tube adjacent the to surface of the bearing tube that the bearing is secured to, wherein the bearing of the bearing tube being received within lands of the threads of the inner tube,
wherein rotation of one of the bearing tube or the threaded tube causes the other one of the bearing tube or the threaded tube to extend or retract with an end of the other one of the bearing tube or the threaded tube secured to the wingtip section causing the wingtip section to extend or retract relative to the root wing section.
